(19) United States
(12) Patent Application Publication
(10) Pub. No.: US 2010/0304341 A1
(43) Pub. Date: Dec. 2, 2010

(54) METHOD AND APPARATUS FOR GUIDING A CHILD IN THE SELF-SELECTION OF A NUTRITIONALLY-BALANCED MEAL IN ORDER TO INCREASE THE LIKELIHOOD THAT THE CHILD WILL CONSUME A NUTRITIONALLY-BALANCED MEAL

(76) Inventor: Tacey Trebino Martinek, Bolton, MA (US)

Correspondence Address: Mark J. Pandiscio;Pandiscio & Pandiscio, P.C., 470 Totten Pond Road, Waltham, MA, 02451-1914, US

(21) Appl. No.: 12/759,405

(22) Filed: Apr. 13, 2010

Related U.S. Application Data
(60) Provisional application No. 61/212,566, filed on Apr. 13, 2009.

(51) Int. Cl. G09B 19/00; B65D 1/34; B65D 85/00

(52) U.S. Cl. 434/127; 206/557; 206/459.5

(57) ABSTRACT

A method for guiding a child in the self-selection of a nutritionally-balanced meal in order to increase the likelihood that the child will consume a nutritionally-balanced meal, the method comprising:
creating a system of food categories according to nutritional content, and associating a unique visual guide with each food category;
providing an offering of food items, each of the food items having the appropriate visual guide displayed therewith;
providing the child with a tray having a plurality of different sections thereon, each of the sections having a visual guide associated therewith; and
instructing the child to self-select a plurality of food items, and place each selected food item in the section of the tray which has a visual guide which matches the visual guide associated with the food category to which that food item belongs, until pre-determined criteria have been satisfied.

### REFERENCE TO PENDING PRIOR PATENT APPLICATION

This patent application claims benefit of pending prior U.S. Provisional Patent Application Ser. No. 61/212,566, filed Apr. 13, 2009 by Tacey Trebino for LET'S BUILD-A-LUNCH TRAY (Attorney's Docket No. TREBINO-1 PROV), which patent application is hereby incorporated herein by reference.

### FIELD OF THE INVENTION

This invention relates to child food services in general, and more particularly to means for guiding a child in the self-selection of a nutritionally-balanced meal in order to increase the likelihood that the child will consume a nutritionally-balanced meal.

### BACKGROUND OF THE INVENTION

### National School Lunch Program (NSLP)

The National School Lunch Program (NSLP) is a federally-assisted meal program operating in over 101,000 public and non-profit private schools and residential childcare institutions. The NSLP is intended to provide nutritionally-balanced, low-cost or free lunches to more than 30 million children each school day.

Generally, public or non-profit private schools of high school grade or under, and public or non-profit private residential childcare institutions, may participate in NSLP. Schools and institutions which choose to participate in NSLP receive cash subsidies and donated commodities from the U.S. Department of Agriculture (USDA) for each meal that they serve. In return, these schools and institutions are required to serve lunches that meet Federal nutritional requirements, and they must offer free or reduced-price lunches to eligible children. These schools and institutions can also be reimbursed for snacks that are served to children through age 18 in after-school educational or enrichment programs.

NSLP lunches must meet the applicable recommendations of the 1995 Dietary Guidelines for

Americans, which recommends that no more than 30 percent of an individual's daily calories come from fat, and less than 10 percent of an individual's daily calories come from saturated fat. Federal regulations also establish a standard for NSLP lunches to provide one-third of the Recommended Dietary Allowances (RDAs) of protein, Vitamin A, Vitamin C, iron, calcium and calories. NSLP lunches must meet Federal nutritional requirements, but the ultimate decisions of what specific foods to serve, and how they are prepared, are determined by local school and institutional food authorities.

Unfortunately, while local school and institutional food authorities strive hard to serve nutritionally-balanced meals, they are unable to ensure that a child will actually consume a nutritionally-balanced meal. This is because there is frequently a disconnect between the food that is served and the food that is actually consumed. In many cases, a nutritionally-balanced meal may be placed on the child's tray, but the child may not care for some or all of the food which has been placed on the tray. In this situation, the child may consume only part of the meal and discard the rest, thereby resulting in the child failing to consume a nutritionally-balanced meal.

As a result, there is an urgent need for a new method and apparatus for increasing the likelihood that the child will consume a nutritionally-balanced meal.

### SUMMARY OF THE INVENTION

The present invention provides a novel method and apparatus for guiding a child in the self-selection of a nutritionally-balanced meal in order to increase the likelihood that the child will consume a nutritionally-balanced meal.

In one preferred form of the present invention, there is provided a method for guiding a child in the self-selection of a nutritionally-balanced meal in order to increase the likelihood that the child will consume a nutritionally-balanced meal, the method comprising:
creating a system of food categories according to nutritional content, and associating a unique visual guide with each food category;
providing an offering of food items, each of the food items having the appropriate visual guide displayed therewith;
providing the child with a tray having a plurality of different sections thereon, each of the sections having a visual guide associated therewith; and
instructing the child to self-select a plurality of food items, and place each selected food item in the section of the tray which has a visual guide which matches the visual guide associated with the food category to which that food item belongs, until pre-determined criteria have been satisfied.

In another preferred form of the present invention, there is provided apparatus for guiding a child in the self-selection of a nutritionally-balanced meal in order to increase the likelihood that the child will consume a nutritionally-balanced meal, the apparatus comprising:
a sign for positioning adjacent to each of a plurality of food items offered to a child, each of the signs bearing a visual guide which corresponds to a food category to which the food item belongs; and
a tray having a plurality of different sections thereon, each of the sections having a visual guide associated therewith.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like elements, and further wherein:

FIGS. 1 and 2 are schematic views showing a sign which provides a child with a visual guide indicating the criteria which must be satisfied as the child self-selects food items from a serving line or food court;

FIG. 3 is a schematic view of a food tray formed in accordance with the present invention, wherein the food tray includes visual guides for assisting the child in self-selecting food items from a serving line or food court;

FIG. 4 is a schematic view showing visual guides placed adjacent to food items in a serving line or food court; and

FIGS. 5 and 6 are schematic views showing other types of visual guides which may be placed adjacent to food items in a serving line or food court.

### DETAILED DESCRIPTION OF THE PREFERRED EMBODIMENTS

### Offer Versus Serve

As noted above, local school and institutional food authorities strive hard to serve nutritionally-balanced meals to their children. However, in practice, these local school and institutional food authorities are unable to ensure that a child will actually consume a nutritionally-balanced meal. This is because merely placing a nutritionally-balanced meal on a child's tray does not ensure that the child will in fact consume that food. In many cases, the child may not care for some or all of the food which has been placed on'their tray. In this situation, the child may consume only part of the meal and discard the rest, thereby resulting in the child failing to consume a nutritionally-balanced meal.

It has been observed that children generally have a higher likelihood of consuming a food item if that food item is to their liking. It has also been observed that there is a higher probability that a food item will be to a child's liking if that child selects that food item themself from a choice of food items.

The present invention capitalizes on these observations by providing a novel method and apparatus for guiding a child in the self-selection of a nutritionally-balanced meal in order to increase the likelihood that the child will consume a nutritionally-balanced meal. More specifically, the present invention offers the child a choice of nutritionally-acceptable food items and permits the child to self-select from among the choice of food items. This process of self-selection is conducted across a range of different food categories, with the child self-selecting amongst offerings in each food category, until a nutritionally-balanced meal has been self-selected by the child. In this way, the child essentially self-selects a nutritionally-balanced meal, whereby to increase the likelihood that the child will actually consume a nutritionally-balanced meal.

### The Food Categories

In accordance with the present invention, food items may generally be classified into one of a plurality of food categories. In one preferred form of the present invention, food items are classified into one of five basic food categories:

Category 1: protein (e.g., meat, cheese, beans, peanut butter, etc.);

Category 2: breads and grains;

Category 3: vegetables;

Category 4: fruit; and

Category 5: milk

However, the present invention also recognizes that certain food items may have a nutritional content which can be properly classified into more than one food category, and whose constituent nutritional elements are unified in such a way that they cannot be easily separated from one another by the student so as to permit separate consumption. In other words, the present invention also recognizes that certain food items may simultaneously fall into more than one food category. In accordance with the present invention, food items of this sort are preferably characterized as “Combination Food Items”, and may be categorized according to any one of its constitutent nutritional elements. Thus, where a Combination Food Item may be properly classified as either Food Category 1 or Food Category 2, the Combination Food Item may be properly classified as falling into either category, as preferred, for purposes of the present invention. Examples of such Combination Food Items include soups, pizza, prepared sandwiches, burritos, etc.

### The Food Offerings

In accordance with the present invention, a child is offered a range of food items from each of the five food categories for self-selection by the child, with each food item being offered in at least the minimum serving size appropriate for that child's age/grade group.

### Food Selection

In one preferred form of the present invention, the child self-selects one food item from the choice of different food items offered for each food category, with the process being repeated until one food item is selected for each food category, thereby ensuring that a nutritionally-balanced meal has been self-selected by the child.

In another preferred form of the present invention, the child self-selects the same number of food items as there are food categories, but is only required to pick food items from a certain number of the food categories. By way of example but not limitation, where there are five food categories, the child self-selects five food items, but is only required to ensure that the food items fall into three of the five food categories.

In still another preferred form of the present invention, the child is permitted to decline making a selection from one or more of the food categories, while still being required to make a selection from others of the food categories. By way of example but not limitation, where there are five food categories, each child may be required to select at least three different food items, with each food item falling into a different food category. By providing the child with the ability to decline making certain selections while requiring them to make others, waste can be minimized (since the child need not select a food item that they do not intend to eat) while still ensuring the consumption of a nutritionally-balanced meal.

### Visual Guides for Guiding a Child in the Self-Selection of a Nutritionally-Balanced Meal

The proper selection of a nutritionally-balanced meal can be a complex task, particularly for young children. Accordingly, in one preferred form of the present invention, visual guides are provided for the child in order to guide the child in the self-selection of a nutritionally-balanced meal. These visual guides are preferably in the form of visual symbols which are easily recognizable across a range of ages. A unique visual symbol is provided for each different food category.

More particularly, in this form of the invention, the child is issued a food tray which has visual guides (i.e., visual symbols) placed on specific sections (e.g., wells) of the food tray. These visual guides correspond to the different food categories to which various food items belong. Corresponding visual guides (i.e., corresponding visual symbols) are also placed adjacent to each food item which is offered to the child in a food line or food court, with the visual guides identifying the particular food category to which a particular food item belongs. As the child moves through the food line or food court and selects specific food items from those being offered to the child, the selected food item is placed in the section of the tray which corresponds to the food category to which the food item belongs. In other words, if a section of the tray is designated as Food Category 1, when the child selects a food item which belongs to Food Category 1, that food item is placed in that section of the tray. In this way, as the child passes through the food line or food court and fills sections on the tray with food items self-selected by the child, the child can readily see how their selected food items fall into different food categories, i.e., by observing which sections of the tray have been filled. By providing the child with simple nutritional criteria characterized in the context of those visual guides (e.g., “match and fill at least 3 sections of your 5 section tray with food items from Food Categories 1, 3 and 5”), the child is naturally induced to self-select a nutritionally-balanced meal.

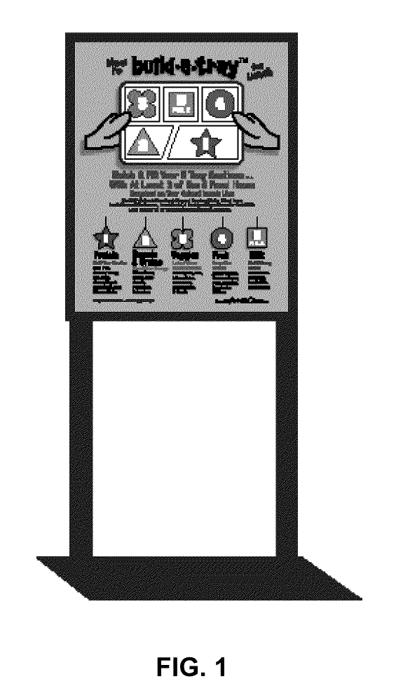

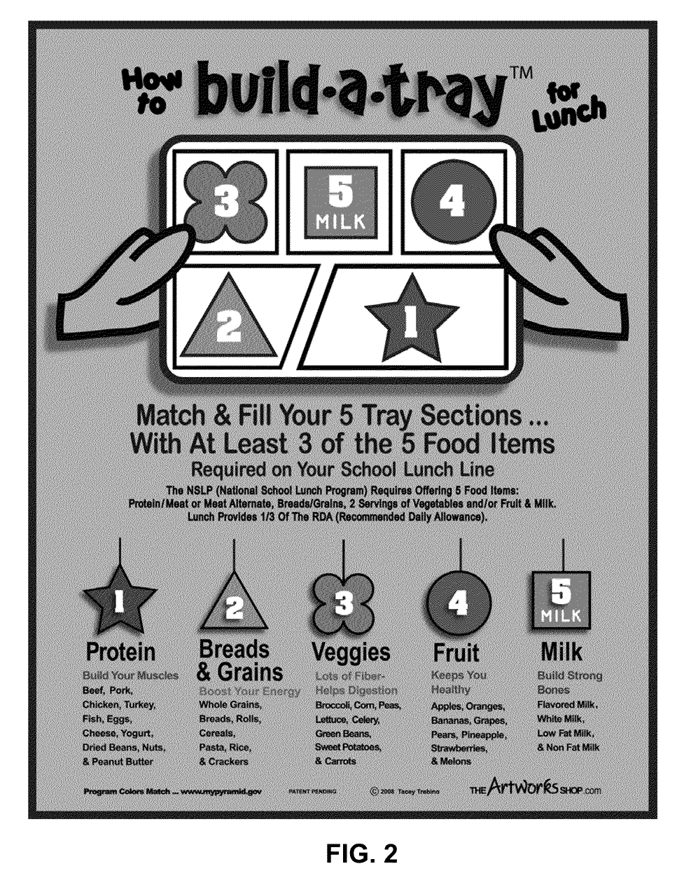

More particularly, and looking now at FIGS. 1 and 2, there is shown signage (e.g., a floor stand) which is preferably placed at the entrance to the food line or food court. As seen in FIGS. 1 and 2, this signage provides the child with a visual guide as to the criteria which must be satisfied as the child self-selects food items in the food line or food court. More particularly, the visual guide informs the child of certain minimum requirements which must be met by the child as the child self-selects food items in the food line or food court. In one preferred form of the invention, where the spectrum of possible food offerings is divided into five basic categories (e.g., protein; breads and grains; vegetables; fruit; and milk), the signage informs the child that they may select any food items they wish so long as they select food items which fall into at least three of the five food categories. Significantly, this approach corresponds to the program guidelines of the National School Lunch Program (NSLP), which are structured in the context of five Food Categories (e.g., protein; breads and grains; vegetables; fruit; and milk), and which are designed to ensure that the child will receive ⅓ of the Recommended Dietary Allowance (RDA) if they consume food items falling into three of the five food categories.

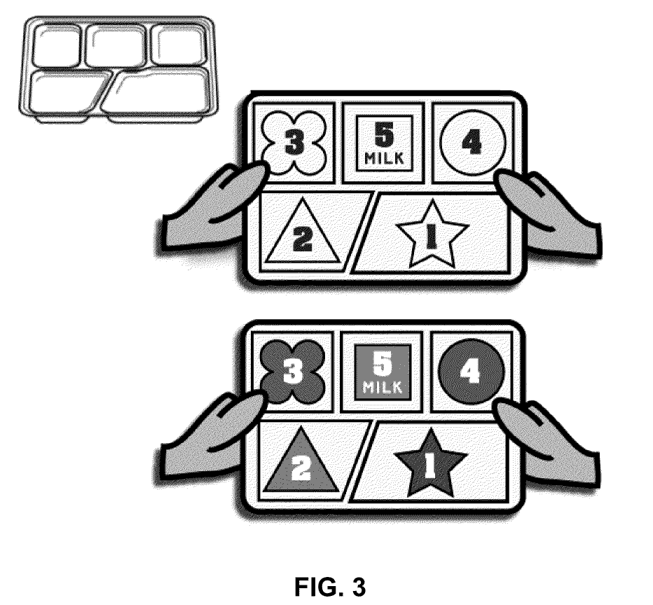

As the child passes by the aforementioned signage, and looking next at FIG. 3, the child receives a food tray. This food tray has multiple sections (e.g., wells) for receiving food items, with each tray section being marked with a visual guide for a food category. Thus, where the spectrum of possible food offerings is divided into five basic categories (e.g., protein; breads and grains; vegetables; fruit; and milk), the child may be given a tray having five different sections, with each section being marked so as to designate a specific food category.

Preferably, the visual guides (i.e., visual symbols) used to mark each food category comprise at least one of a number, a shape and a color. More preferably, and as seen in FIGS. 1-3, the visual guides used to mark each food category simultaneously comprise all three of a number, a shape and a color, with the three attributes collectively forming a unique visual guide (i.e., visual symbol) for identifying a particular food category.

By way of example but not limitation, for Food Category 1, the associated number may be “1”, the shape may be a star and the color may be purple; for Food Category 2, the associated number may be “2”, the shape may be a triangle and the color may be orange; for Food

Category 3, the associated number may be “3”, the shape may be a cloverleaf and the color may be green; for Food Category 4, the associated number may be “4”, the shape may be a circle and the color may be red; and for Food Category 5, the associated number may be “5”, the shape may be a square and the color may be blue.

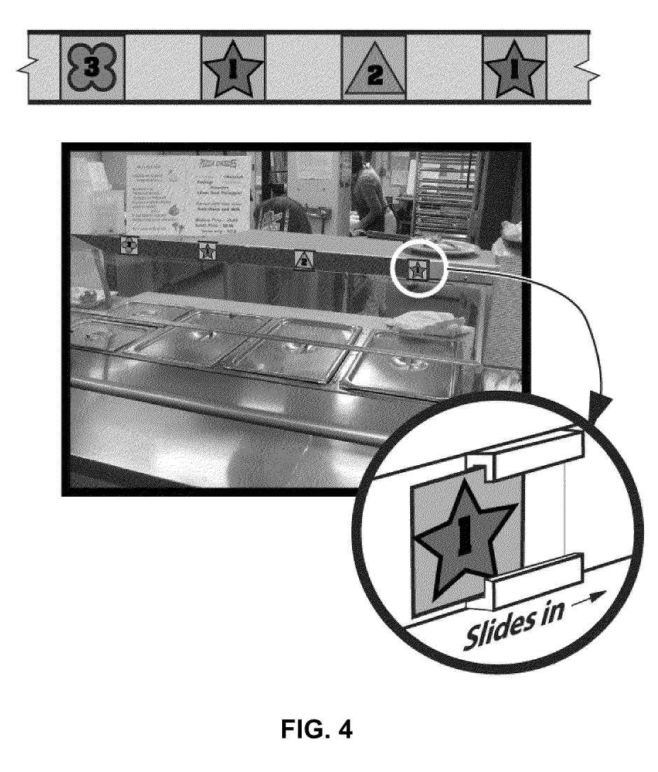

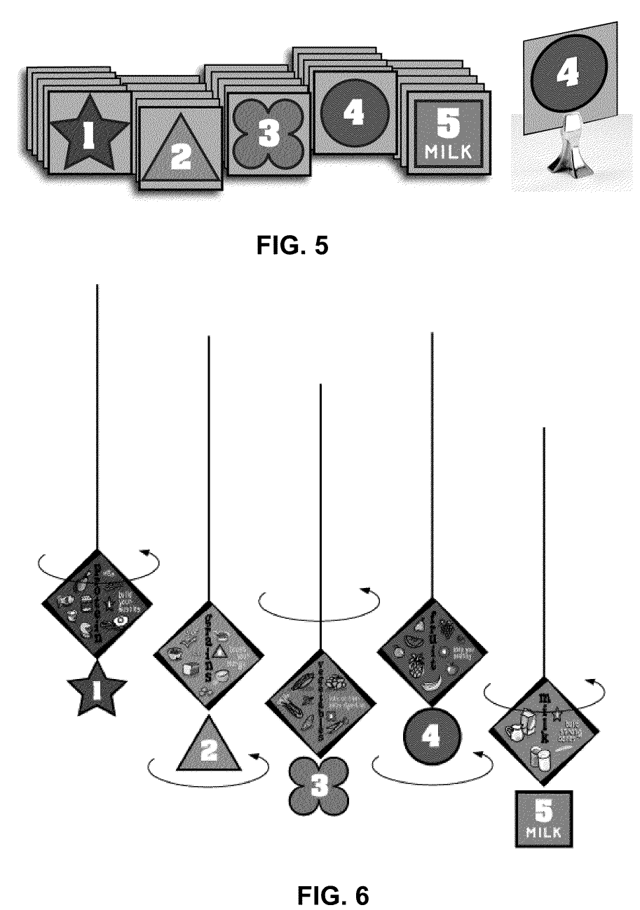

After the child receives their tray, and looking now at FIG. 4, the child passes through the food line or food court. Next to each of the food items offered in the food line or food court, there is displayed a visual guide (i.e., visual symbol) which corresponds to the food category to which that food item belongs. The visual guides placed adjacent to the food items. correspond to the visual guides marked on the child's tray, thereby providing a simple approach for matching the food items with the food categories. The visual guides placed adjacent to the food items may be in the form of cards placed into sign channels located adjacent to the food item (e.g., as seen in FIG. 4), and/or cards placed into clip holders located adjacent to the food item (e.g., as seen in FIG. 5), and/or danglers suspended above the food item (e.g., as seen in FIG. 6), etc.

As the child moves through the food line or food court and selects specific food items from among those being offered to the child, the selected food item is placed in the section of the tray which corresponds to the food category to which the food item belongs. In other words, if a section of the tray is designated as Food Category 1, when the child selects a food item which belongs to Food Category 1, that food item is placed in that section of the tray. In this way, as the student passes through the food line and fills the sections of the tray with food items self-selected by the student, the child is induced to select a range of food items. So long as the child satisfies the criteria previously established (e.g., select and fill three out of five tray sections with an appropriate food item), the child will have effortlessly selected a nutritionally-balanced meal.

Significantly, since the child will have self-selected each food item from a choice of food items, there is a higher likelihood that the child will have a desire to eat the selected food item, thereby enhancing the likelihood that the child will in fact consume a nutritionally-balanced meal.

Furthermore, it will be appreciated that inasmuch as the child self-selects their food items using a simple symbol-matching process, even young children will be capable of self-selecting a meal satisfying minimal nutrition criteria. In fact, it has been found that young children find food selection using the aforementioned symbol matching process to be something of a “game”, which appears to increase their enthusiasm for the process and hence increases the likelihood that they will consume a nutritionally-balanced meal. Additionally, by placing commentary in association with the visual guides (e.g., “Protein: Build Your Muscles”, or “Breads & Grains: Boost Your Energy”), it has also been found that the process of food selection has an educational impact on the child.

### Modifications

It will be understood that many additional changes in the details, materials, steps and arrangements of elements, which have been herein described and illustrated in order to explain the nature of the invention, may be made by those skilled in the art while remaining within the principles and scope of the present invention.

What is claimed is:

1. A method for guiding a child in the self-selection of a nutritionally-balanced meal in order to increase the likelihood that the child will consume a nutritionally-balanced meal, the method comprising:
creating a system of food categories according to nutritional content, and associating a unique visual guide with each food category;
providing an offering of food items, each of the food items having the appropriate visual guide displayed therewith;
providing the child with a tray having a plurality of different sections thereon, each of the sections having a visual guide associated therewith; and
instructing the child to self-select a plurality of food items, and place each selected food item in the section of the tray which has a visual guide which matches the visual guide associated with the food category to which that food item belongs, until pre-determined criteria have been satisfied.

2. A method according to claim 1 wherein there are five food categories.

3. A method according to claim 2 wherein the five food categories are protein; breads and grains; vegetables; fruit; and milk.

4. A method according to claim 1 wherein each unique visual guide comprises at least one of a number, a shape and a color.

5. A method according to claim 4 wherein each unique visual guide simultaneously comprises all three of a number, a shape and a color.

6. A method according to claim 1 wherein the unique visual guide comprises a shape selected from the group consisting of a star, a triangle, a cloverleaf, a circle and a square.

7. A method according to claim 1 wherein the appropriate visual guide is displayed with each food item using at least one from the group consisting of a card placed into a sign channel, a card placed into a clip holder, a dangler suspended above the food item, and another form of signage.

8. A method according to claim 1 wherein the tray comprises a plurality of wells, and further wherein each of the wells has a visual guide associated therewith.

9. A method according to claim 1 wherein the child is instructed to self-select one food item from the range of different food items offered for each food category, with the process being repeated until one food item is selected for each food category.

10. A method according to claim 1 wherein the child is instructed to self-select the same number of food items as there are food categories, but is only required to pick food items from a selected number of the food categories.

11. A method according to claim 10 wherein there are five food categories, and the child is instructed to self-select five food items, but is only required to ensure that the selected food items fall into three of the five food categories.

12. A method according to claim 1 wherein the child is permitted to decline making a selection from one or more of the food categories, while still being required to make a selection from others of the food categories.

13. A method according to claim 12 wherein there are five food categories, and each child is required to select at least three different food items, with each food item falling into a different food category.

14. Apparatus for guiding a child in the self-selection of a nutritionally-balanced meal in order to increase the likelihood that the child will consume a nutritionally-balanced meal, the apparatus comprising:
a sign for positioning adjacent to each of a plurality of food items offered to a child, each of the signs bearing a visual guide which corresponds to a food category to which the food item belongs; and
a tray having a plurality of different sections thereon, each of the sections having a visual guide associated therewith.

15. Apparatus according to claim 14 wherein the signage comprises a card placed into a sign channel, a card placed into a clip holder, a dangler suspended above the food item, and another form of signage.

16. Apparatus according to claim 14 wherein the visual guide comprises at least one of a number, a shape and a color.

17. Apparatus according to claim 16 wherein the visual guide simultaneously comprises all three of a number, a shape and a color.

18. Apparatus according to claim 16 wherein the visual guide comprises a shape selected from the group consisting of a star, a triangle, a cloverleaf, a circle and a square.

19. Apparatus according to claim 14 wherein the tray comprises a plurality of wells, and further wherein each of the wells has a visual guide associated therewith.
